(19) United States
(12) Patent Application Publication
(10) Pub. No.: US 2005/0257142 A1
(43) Pub. Date: Nov. 17, 2005

(54) Portable communication device and multimedia message processing method for same

(76) Inventors: Cheng-Shing Lai, Taipei (TW); Chang Jiang Shi, Nanjing City (CN); Jun Huang, Nanjing City (CN)

Correspondence Address: BIRCH STEWART KOLASCH & BIRCH, PO BOX 747, FALLS CHURCH, VA, 22040-0747, US

(21) Appl. No.: 10/844,358

(22) Filed: May 13, 2004

(51) Int. Cl. G06F 7/00; G06F 17/24

(52) U.S. Cl. 715/523

(57) ABSTRACT

A portable communication device. The portable communication device comprises an editing module, a converting module, a message processing module, and a communication module. The editing module processes a multimedia message, wherein the multimedia message comprises text and image data. The converting module converts the multimedia message into a HyperText Markup Language (HTML) document, wherein the document presents the text and image data according to a cascading style sheet (CSS) property. The message processing module generates an e-mail message having a HTML document attachment.

### BACKGROUND OF THE INVENTION

1. Field of the Invention

The present invention relates to communication device and in particular to a portable communication device capable of transmitting multimedia e-mail messages.

2. Description of the Related Art

Many portable communication devices, such as mobile phones and personal digital assistants (PDAs), have the ability to send multimedia messages. Generally, multimedia message can only be displayed on a receiving of the same model as the sending device. When the sending and receiving devices are different models, the multimedia message cannot be displayed as defined by the sender. For example, when multimedia message having contents embedded in an image is sent from a model A device to a model B device, the contents of the multimedia message are presented in the model B device as a text message, and the image is a separate attachment.

Hence, there is a need for a system which addresses the problems of multimedia message presentation arising from the existing technology.

### SUMMARY OF THE INVENTION

It is therefore an object of the invention to provide a system and method for processing multimedia messages in a portable communication device.

To achieve this and other objects, the present invention provides a portable communication device. The portable communication device comprises an editing module, a converting module, a message processing module, and a communication module. The editing module processes a multimedia message, wherein the multimedia message comprises text and image data. The converting module converts the multimedia message into a HyperText Markup Language (HTML) document, wherein the presentation of text and image data is defined by cascading style sheet (CSS) properties. The message processing module generates an e-mail message having a HTML document attachment.

The invention also provides a method for processing a multimedia message using a portable communication device. First, a multimedia message is provided, wherein the multimedia message comprises text and image data. The multimedia message is then converted into a HyperText Markup Language (HTML) document, wherein the presentation of text and image data is defined by cascading style sheet (CSS) properties. An e-mail message is then generated with the HTML attachment.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a device of the present invention;

FIG. 2 is a flowchart of a method of the present invention;

FIGS. 3A and 3B illustrate HTML documents according to the present invention;

FIG. 4A illustrates an image according to the present invention; and

FIG. 4B illustrates a display of the HTML document according to the present invention; and

FIG. 5 is a diagram of a storage medium for storing a computer program embodying the method according to the present invention.

### DETAILED DESCRIPTION OF THE INVENTION

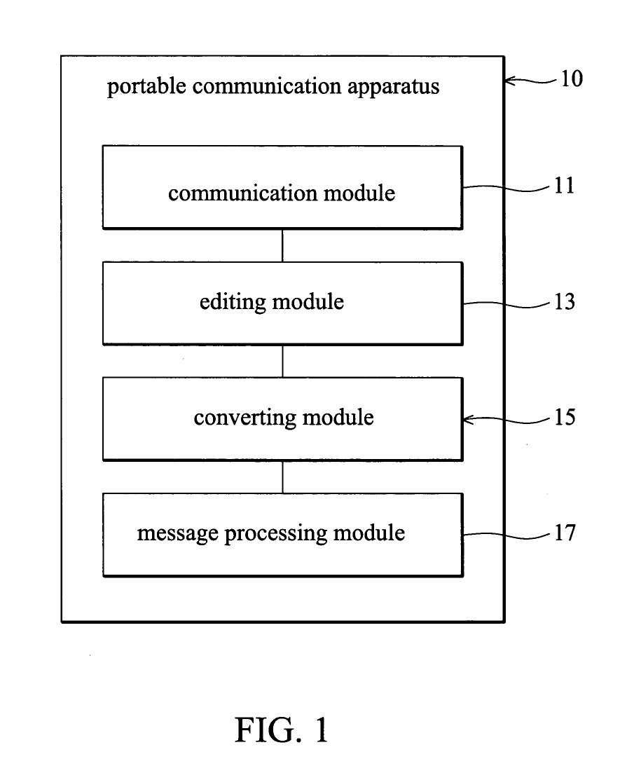

The present invention provides a portable communication device. FIG. 1 is a schematic view of a portable communication device of the present invention. A portable communication device 10 can be a personal digital assistant (PDA) device or a mobile phone, comprising an editing module 13, a converting module 15, a message processing module 17, and a communication module 11.

The editing module 13 creates a multimedia message. The multimedia message comprises text and image data.

The converting module 15 converts the multimedia message into a HyperText Markup Language (HTML) document, wherein the presentation of text and image data is defined by cascading style sheet (CSS) properties.

The converting module 15 displays the HTML document as defined by CSS properties, generates a head element and title information in the HTML document, and generates an image <IMG> tag, comprises the image location and layout thereof corresponding to CSS properties in the HTML document. The CSS properties comprise at least position and layer properties. The position property specifies the arrangement of an image embedded in a frame, comprising coordinate setting (absolute or relative coordinate system), horizontal position setting, and vertical position setting. The layer property specifies layer arrangement of an image embedded in a frame. For example, the layer property uses a Z-index to specify a position in the third dimension along the Z-axis.

The converting module 15 also generates a text tag directing layout of the text data and corresponding CSS properties, wherein the CSS properties comprise a position, layer, and style properties.

Additionally, the converting module 15 generates a sound tag corresponding to sound data of the multimedia message.

The message processing module 17 generates an e-mail message having a HTML document attachment. The communication module 11 transmits the e-mail message via a wireless and/or wired network. The receiver of the e-mail message is an device capable of wireless and/or wire communication and HTML document processing, such as a computer, a personal digital assistant, a mobile phone, and the like.

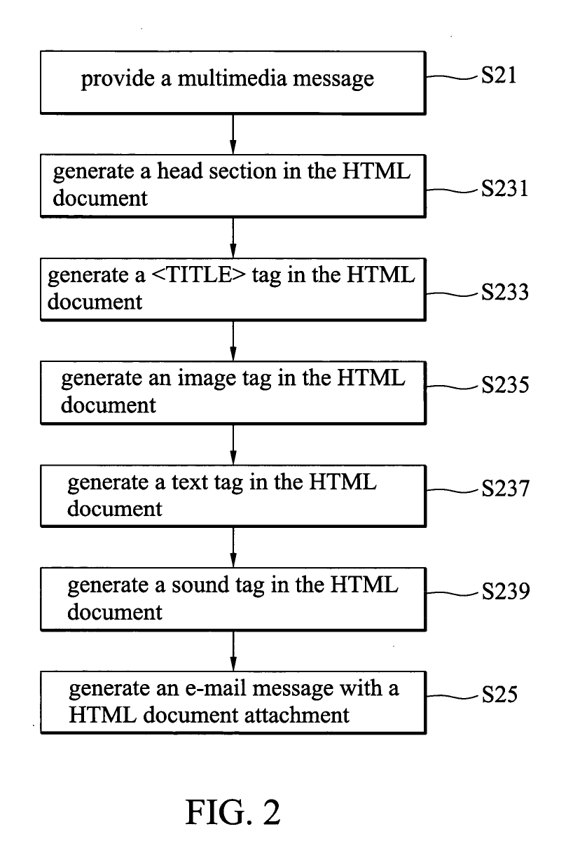

FIG. 2 is a flowchart of a method of the present invention.

First, a multimedia message is provided (step S21), wherein the multimedia message comprises text and image data.

The multimedia message is then converted into a HyperText Markup Language (HTML) document. The HTML document presents the text and image data as defined by at least one cascading style sheet (CSS) property. For example, the position and layer properties specify layout of elements presented on a screen. When an element is referred to as ‘positioned’ in the visual formatting model, it may or may not be rendered immediately after the previous element in the document tree. A rendered element that is positioned (‘position’ property ) may be offset from the canvas origin or from its normal flow position via the ‘top’, ‘right’, ‘bottom’, and ‘left’ properties. In addition to determining position offsets, positioning properties also specify the visible display area of a rendering box (‘clip’) for an element and directives indicating what should happen when element content falls outside the rendering box (‘overflow’). Positioning in CSS, however, is not limited to rendering 2-dimensional. It also allows for placement and overlap of elements in an imaginary third dimension perpendicular to the screen (‘z-axis’). The final property included in this category, ‘vertical-align’, is not involved with “CSS positioning” per se, but it does involve vertical positioning of content within a rendered line box. Many of these properties were first introduced prior to CSS2 in the W3C Working draft “Positioning HTML Elements with Cascading Style Sheets” (http://www.w3.org/TR/WD-positioning, Robert Steven, Scott Furman, Scott Isaacs, et. al, 19 Aug. 1997).

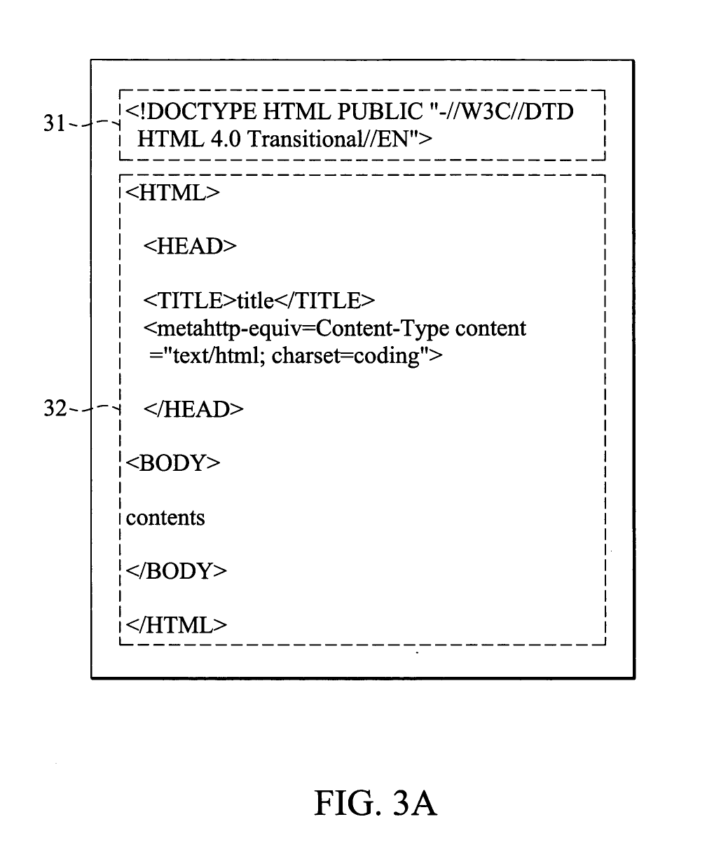

The multi-media message is then converted to a HTML document, thus the text and image data can be presented as overlapping as defined by a set of CSS properties. It takes four steps to convert the multi-media message to a HTML document, shown in FIGS. 3A and 3B. First, a head section for the HTML document is generated (steps S231), and a <TITLE> tag is added thereto (step S233). The head section is similar to the cover page of the document. Just as the cover page of a book contains information about the book (such as the title), the head section contains information about the HTML document. This information is communicated through the <TITLE> tag (which is required) and the <LINK . . . > and <META . . . > tags. Second, a body section of the HTML document is generated. The body section contains the visible contents of the document, and comprises a number of attributes which define the overall document appearance. In step S235, an image tag <IMG> is generated, specifying the location and layout of image data and corresponding CSS syntax for the HTML document. In step S237, a <b> tag is generated, formatting the text data and corresponding to CSS syntax.

If the multimedia message comprises sound data, a sound tag <bgsound> is further generated (step S239). The <bgsound> tag enables the sound data to be given output when the HTML documented is accessed.

An e-mail message is then generated with a HTML document attachment (step S25). The e-mail message is then transmitted through the communication module 11. Any device capable of displaying HTML can presents the multimedia message attached to the e-mail message as defined by the sender of the e-mail message.

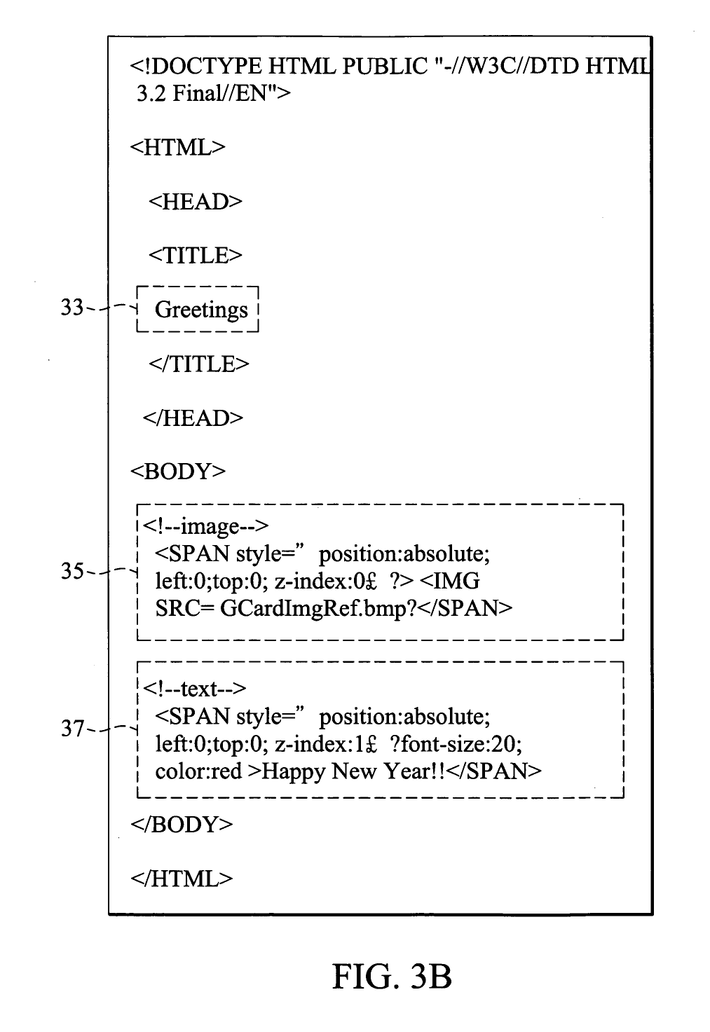

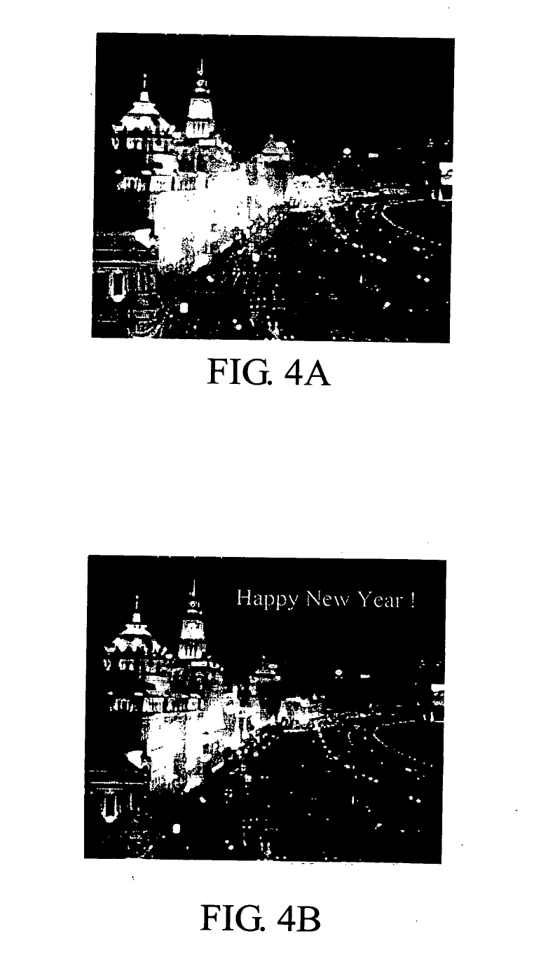

Referring to FIGS. 3A, 3B, 4A and 4B, a multimedia message is generated and sent using a mobile phone. First, a multimedia message is created, wherein the multimedia message comprises text and image data. The image data is the background picture of the multimedia message, and the text data contains contents of the multimedia message. Sound data may be added to the multimedia message as the background sound thereof. As shown in FIG. 4A, an image data file, entitled GcardImgRef.bmp, is the background image of the multimedia message. The subject of the multimedia message, “Greetings”, and the contents thereof, Happy New Year, are then provided. The contents of the multimedia message can be presented as defined by the sender. After the multi-media message has been created, it can be previewed on the screen of the mobile phone. The multimedia message is then converted into a HTML document, “GreetingCard.html”, as shown in FIG. 4B. First, a head section for the HTML document is generated, and a <TITLE> tag is added thereto, as shown in blocks 31 and 32 of FIG. 3A. When the multimedia message comprises image data, an image tag <IMG> is generated, specifying the location and layout of the image data, GcardImgRef.bmp, of the multimedia message. The image data is presented as defined by corresponding CSS syntax thereof, as shown in block 35 of FIG. 3B. A <b> tag is then generated, directing to the text data and corresponding CSS syntax, as shown in block 37 of FIG. 3B. If the multimedia message comprises sound data, a sound tag <bgsound> is further generated. An e-mail message is then generated with the HTML document (GreetingCard.html) attachment. The e-mail message is then transmitted through the communication module 11. Any device capable of displaying HTML can presents the multimedia message attached to the e-mail message as defined by the sender, as shown in FIG. 4B.

The methods and system of the present invention, or certain aspects or portions thereof, may take the form of program code (i.e., instructions) embodied in tangible media, such as flash memory in a mobile phone, wherein, when the program code is loaded into and executed by a portable communication device, such as a mobile phone, the mobile phone becomes an system for practicing the invention. The methods and system of the present invention may also be embodied in the form of program code transmitted over some transmission medium, such as electrical wiring or cabling, through fiber optics, or via any other form of transmission, wherein, when the program code is received and loaded into and executed by a portable communication device, such as a mobile phone, the mobile phone becomes an system for practicing the invention. When implemented on a general-purpose processor, the program code combines with the processor to provide a unique system that operates analogously to specific logic circuits.

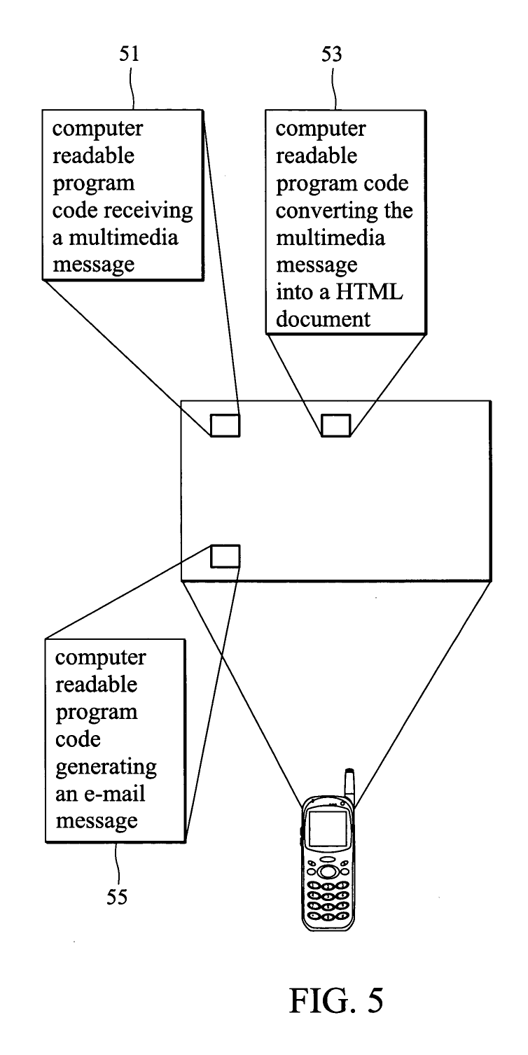

FIG. 5 is a diagram of a storage medium for storing a computer program embodying the method according to the present invention.

The computer program product comprising a computer usable storage medium having computer readable program code embodied in the medium, the computer readable program code comprising computer readable program code 51 receiving a multimedia message, a computer readable program code 53 converting the multimedia message into a HyperText Markup Language (HTML) document, and a computer readable program code 55 generating an e-mail message attached with the HTML document.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A portable communication device, comprising:
an editing module, processing a multimedia message, wherein the multimedia message comprises text and image data;
a converting module, converting the multimedia message into a HyperText Markup Language (HTML) document, wherein the document presents the text and image data as defined by a cascading style sheet (CSS) property;
a message processing module, generating an e-mail message with the HTML document attachment; and
a communication module, transmitting the e-mail message.

2. The portable communication device of claim 1, wherein the converting module further displays the HTML document and the appearance thereof is defined by the CSS property.

3. The portable communication device of claim 1, wherein the converting module further generates a head section for the HTML document.

4. The portable communication device of claim 1, wherein the converting module further generates title information in the HTML document.

5. The portable communication device of claim 1, wherein the converting module further generates an image tag comprising image data corresponding to CSS syntax for the HTML document, wherein the CSS properties comprise position and layer properties.

6. The portable communication device of claim 1, wherein the converting module further generates a text tag comprising text data and corresponding CSS syntax.

7. A portable communication device of claim 1, wherein the multimedia message further comprises sound data.

8. The portable communication device of claim 7, wherein the converting module further generates a sound tag comprising sound data.

9. A method for processing a multimedia e-mail message using a portable communication device, comprising:
providing a multimedia message, wherein the multimedia message comprises text and image data;
converting the multimedia message into a HyperText Markup Language (HTML) document, wherein the document presents the text and image data according to a cascading style sheet (CSS) property; and
generating an e-mail message with the HTML document attached thereto.

10. The method of claim 9, further displaying the HTML document according to a CSS property.

11. The method of claim 9, wherein the converting step further generates a head element in the HTML document.

12. The method of claim 9, wherein the converting step further generates title information in the HTML document.

13. The method of claim 9, wherein the converting step further generates an image tag comprising the image data corresponding to CSS properties in the HTML document, wherein the CSS properties comprise position and layer properties.

14. The method of claim 9, wherein the converting step further generates a text tag comprising text data and corresponding CSS properties, wherein the CSS properties comprise a position, layer, and style properties.

15. A computer readable storage medium for storing a computer program providing a method for processing a multimedia e-mail message using a portable communication device, the method comprising:
receiving a multimedia message, wherein the multimedia message comprises text and image data;
converting the multimedia message into a HyperText Markup Language (HTML) document, wherein the document presents the text and image data according to a cascading style sheet (CSS) property; and
generating an e-mail message with the HTML document attached thereto.

16. The storage medium of claim 15, wherein the method further displays the HTML document with an appearance as defined by the CSS property.

17. The storage medium of claim 15, wherein the method further generates head element in the HTML document.

18. The storage medium of claim 15, wherein the method further generates title information in the HTML document.

19. The storage medium of claim 15, wherein the method further generates an image tag comprising the image data corresponding to CSS properties in the HTML document, wherein the CSS properties comprise position and layer properties.

20. The storage medium of claim 15, wherein the method further generates a text tag comprising the text data corresponding to CSS properties, wherein the CSS properties comprise position, layer, and style properties.
